(19) United States
(12) Patent Application Publication
(10) Pub. No.: US 2021/0002924 A1
(43) Pub. Date: Jan. 7, 2021

(54) A LOCK ASSEMBLY

(71) Applicant: ASSA ABLOY NEW ZEALAND LIMITED, North Shore City (NZ)

(72) Inventors: Stuart HORWOOD, Auckland (NZ); Samuel JOHNSON, Auckland (NZ)

(21) Appl. No.: 16/981,187

(22) PCT Filed: Mar. 11, 2019
(86) PCT No.: PCT/NZ2019/050025

§ 371 Date: Sep. 15, 2020

(30) Foreign Application Priority Data
Mar. 16, 2018 (NZ) 740808

(51) Int. Cl. E05B 59/00; E05B 63/00; E05B 65/08

(52) U.S. Cl. CPC E05B 59/00; E05B 65/0864; E05B 2063/0082; E05B 63/0065

(57) ABSTRACT

A lock assembly comprising: a roatable lock cylinder comprising a portion configurable between an unlocked position, a locked position, and a deadlocked position; and a linking member having a first position and a second position, wherein when the portion is in the unlocked position, the linking member is in the first position, when the portion is in the locked position, the linking member is in the second position, and when the portion is in the deadlocked position, the linking member is locked in the second position; wherein, the lock assembly is configured to be installed in a mortice of a sliding door, the sliding door having a latch mechanism, such that the linking member is in communication with the latch mechanism.

### TECHNICAL FIELD

The invention relates to an assembly for installation in a mortice of a sliding door, and in particular a mortice lock assembly for use with a latch mechanism in a sliding door.

### BACKGROUND

Sliding doors are often provided with a latch mechanism to hold the door in place. For example, a latch mechanism may include a latch which extends into a strike plate in the jamb of the door frame to hold the door in place. The latch can then be selectively extended and withdrawn.

In some cases, it is desirable to further provide a locking mechanism on a sliding door for additional security. While previous attempts have been made to provide a suitable lock mechanism for sliding doors, such approaches may not be suitable for a particular application.

### SUMMARY

In a first aspect, there is provided a lock assembly, comprising: a lock body; a rotatable lock cylinder comprising a portion movable within the lock body and configurable between an unlocked position, a locked position, and a deadlocked position; and a linking member having a first position and a second position, wherein when the portion is in the unlocked position, the linking member is in the first position, when the portion is in the locked position, the linking member is in the second position, and when the portion is in the deadlocked position, the linking member is locked in the second position; wherein the lock assembly is configured to be installed in a mortice of a sliding door, the sliding door having a latch mechanism within a latch body separate from the lock body, such that the linking member is in communication with the latch mechanism via a drive plate, drive bar or actuator arm configured to connect to the linking member and positioned outside the lock body and the latch body.

Such a mortice lock assembly provides a mechanism to selectively use the deadlock in a sliding door. That is, due to the cylinder lock having a separate first lock position and second lock position, the sliding door can be latched and unlatched by operation of the cylinder lock without necessarily engaging a deadlock. In addition, the door can be configured to allow to disallow latching and unlatched via the latch mechanism in a mode when the door is deadlocked. This enhances the configurability of the door, and thus improves convenience and safety.

The lock cylinder may comprise a cam and the linking member may comprise a follower configured to interact with the cam. Rotation of the lock cylinder may correspond to rotation of the cam about the same axis. This provides a convenient method in which rotational movement of the lock cylinder is translatable to linear movement of the linking member.

The lock assembly may further comprise a locking arm having a deadlocked position and a free position, wherein when the lock cylinder is in the locked position, the locking arm is in the free position and the linking member is in the first position or the second position, and when the lock cylinder is in the deadlocked position, the locking arm is in the deadlocked position to lock the linking member in the second position. In this manner, the locking arm provides a convenient deadlock function which is engageable by movement of the cylinder lock.

The locking arm may be biased towards the deadlocked position, wherein when the lock cylinder is in the unlocked position or the locked position, the cam can hold the locking arm in the free position. In this manner, the deadlock is automatically engaged when the lock cylinder is appropriately rotated.

In some embodiments, the locking arm comprises a protrusion and the follower comprises a groove, wherein when the locking arm is in the deadlocked position, the protrusion engages the linking member to lock the linking member in the second position, and when the locking arm is in the free position, the protrusion aligns with the groove to allow the linking member to move between the first position and the second position. This provides a reliable mechanism to selectively retain the linking member, and thus to engage the deadlock.

The follower may comprise a pair of fingers, the cam acting on one or both fingers to actuate the linking member between the first position and the second position. For example, the cam may sit between the fingers, where the cam pushes against the inner face of each finger. In this manner, because a pair of fingers is provided, movement of the cam in either direction will engage the follower, and so will be translated to the linking member.

The follower may move linearly along an axis transverse to the axis of rotation of the lock cylinder. Since the latch mechanism may be oriented generally along the same transverse axis, this can allow the movement of the follower to be integrated into the latch mechanism.

When the lock assembly is installed, the drive plate, drive bar or actuator arm may translate movement of a snib of the sliding door to movement of the linking member. This allows the locking assembly to be integrated with a wide range of snibs and latch mechanisms, since the latch mechanism need only have a simple interface with the drive plate.

The linking member may be able to move between the first position and the second position by movement of the snib. This allows the user to conveniently actuate the lock cylinder between the unlocked position and the locked position by using a snib.

The lock cylinder may be the lock cylinder of a Euro cylinder lock. Such a Euro cylinder lock provides a high degree of security, and therefore enhances the security of the lock assembly and the sliding door generally.

The lock body may be configured to mate with the latch body. This reduces the footprint of the lock assembly when installed, allowing for an easier installation within the mortice, and allows for a simply retrofit of an existing latch mechanism.

In a second aspect, there is provides a lockable latch assembly, comprising: the lock assembly of the first aspect; and a latch mechanism comprising a latch, the latch mechanism having a latched mode in which a latch of the latch mechanism is extended and an unlatched mode in which a latch of the latch mechanism is withdrawn; wherein when the lock cylinder of the lock assembly is in the unlocked position, the latch mechanism is in the unlatched mode, and when the lock cylinder of the lock assembly is in the locked position or the deadlocked position, the latch mechanism is in the latched mode.

Such a lockable mortice latch assembly provides a convenient mechanism to provide a sliding door with a latch and a selectively usable deadlock. This enhances the configurability of the door, and thus improves convenience and safety.

In a third aspect, there is provided a lockable multi-latch assembly, comprising: the lock assembly of the first aspect, and two or more latch mechanisms in communication with the lock assembly, each latch mechanism comprising a latch, and having a latched mode in which a latch of the latch mechanism is extended and an unlatched mode in which a latch of the latch mechanism is withdrawn; wherein when the lock cylinder of the lock assembly is in the unlocked position, each latch mechanism is in the unlatched mode, and when the lock cylinder of the lock assembly is in the locked position or the deadlocked position, each latch mechanism is in the latched mode.

Such a lockable multi-latch assembly provides a convenient method for including the benefits of the lock assembly of the first aspect to a sliding door in which multiple latches would be beneficial. For example, a particularly tall sliding door may benefit from a number of latches along its height.

The multi-latch assembly may further comprise a forend plate to which the lock assembly and each latch mechanism are connected. This integrates the components into a single system for simple installation. Moreover, when the forend plate covers the outer edge of the mortice, this avoids components being easily accessible from the edge of the sliding door, improving security.

In a fourth aspect, there is provided a sliding door having one or more mortices, wherein the lock assembly of the first aspect, the latch assembly of the second aspect, or the multi-latch assembly of the third aspect is installed in one or more of the mortices. For example, the different components of each assembly may be installed in different mortices, or all components may be installed in the same mortice, depending on the particular configuration of the sliding door and the desired positions of the components.

### BRIEF DESCRIPTION OF DRAWINGS

The invention will be described by way of example with reference to the drawings, which show various preferred embodiments of the invention. However, these are provided for illustration only, and the invention is not limited to the particular details of the drawings and the corresponding description.

FIG. 1 shows an example sliding door which may include a lock assembly according to an embodiment of the present invention.

FIGS. 2, 3, and 4 show a communicating lock assembly and latch assembly in which the cam of the lock assembly is in an unlocked position, locked position, and deadlocked position respectively.

FIG. 5 shows an isometric view of a lock assembly in partially exploded form.

FIGS. 6, 7, and 8 show a lock assembly in which the cam of the lock assembly is in an unlocked position, locked position, and deadlocked position respectively.

FIGS. 9, 10, and 11 show a lockable latch assembly in which the cam of the lock assembly is in an unlocked position, locked position, and deadlocked position respectively.

FIGS. 12,13, and 14 show a communicating lock assembly, latch assembly, and latch mechanism in which the cam of the lock assembly is in an unlocked position, locked position, and deadlocked position respectively.

FIGS. 15, 16, and 17 show a lockable multi-latch assembly in which the cam of the lock assembly is in an unlocked position, locked position, and deadlocked position respectively.

### DETAILED DESCRIPTION

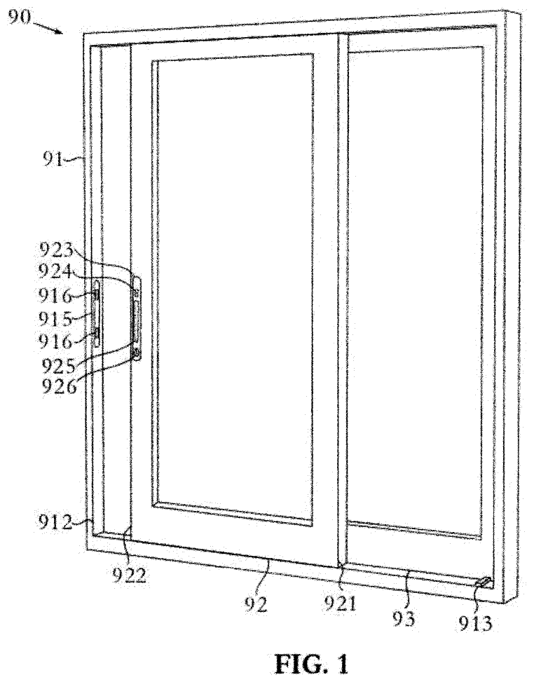

FIG. 1 shows an example embodiment of a sliding door 90, which includes a frame 91, a fixed glass panel 93, and a sliding glass panel 92. The sliding glass panel 92 slides from a closed position on the left to an open position on the right. In the closed position the lock stile 922 of the sliding panel 92 abuts the jamb 912 of the frame 91, and the lock can be engaged. The interlock stile 921 of the sliding glass panel 92 and the fixed panel stile also inter-engage to provide a sealed closure.

A fixed handle 925 is attached to the inside of the sliding glass panel 92 to allow a user to slide the door open or closed. The sliding glass panel 92 may be supported and slide on wheels or rollers running on a track in the bottom rail or suspended from the top rail, to allow the sliding glass panel 92 to side with minimal user effort. In the open position, the interlock stile 921 of the sliding glass panel 92 abuts a stop or abutment 913 on the frame 91 to prevent the sliding glass panel 92 hitting the frame 91.

The lock includes a strike plate 915 bolted to the jamb 912, a mortice latch (mounted within the lock stile 922) which engages the strike plate 915, and a mortice lock cylinder and/or snib 924 which actuate the latch 923. The latch 923 may include two beaks which counter rotate to seat within apertures 916 of the strike plate 915 to prevent horizontal movement of the sliding glass panel 92 (that is, so that the door is locked), and prevent vertical movement of the sliding glass panel 92 (that is, to provide an anti-lift function). A user can rotate the snib 924 from inside the door to operate the latches from the locked or unlocked positions. The latch may include an anti-slam mechanism which prevents the latch 923 being locked unless it is engaged against the jamb 912.

The cylinder lock 926 may be configured as a dual-select configuration. This may allow three positions with a matching key inserted. A first unlocked position corresponds to the unlocked position of the snib 924 in which the beaks are unengaged. In a second locked position, the snib 924 is still operable to move the beaks between the locked position and the unlocked position. In a third deadlocked position, the beaks are engaged with the strike plate 915 and the snib 924 is disabled and locked in place, and the snib 924 cannot be used to move the beaks between a locked position and unlocked position. The lock may include cylinders on the internal and external sides of the door.

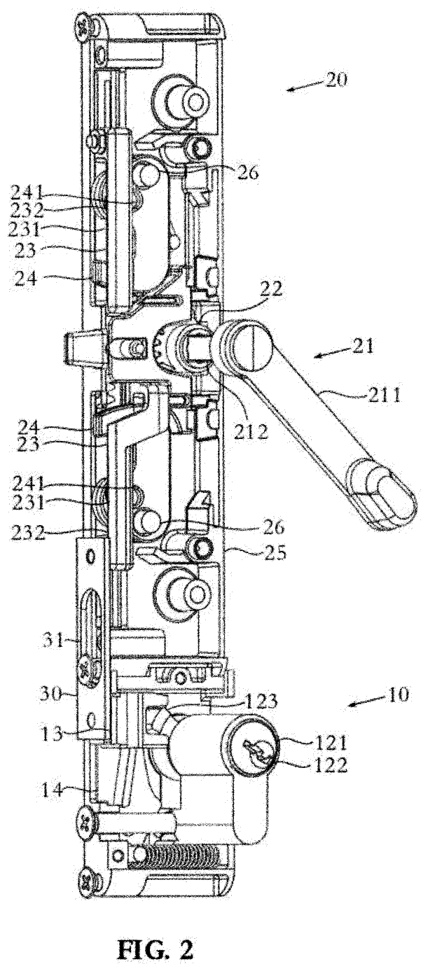

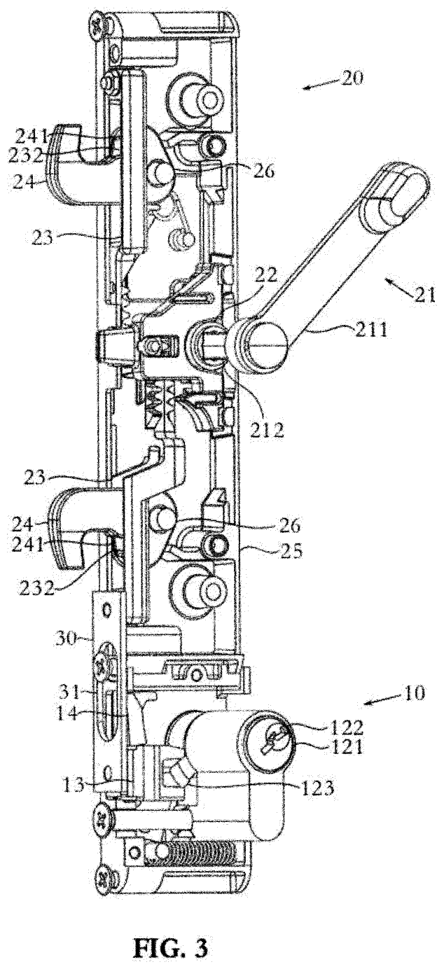

The dual-select configuration is now described in more detail with reference to FIG. 2, which shows a lock assembly 10 installed alongside a latch assembly 20.

The lock assembly 10 includes a cylinder lock 12, a follower 13, and a locking arm 14.

The cylinder lock 12 includes a lock cylinder 121 rotatable about an axis, and a cam 123 rotatable about the same axis, when a suitable key is inserted into a keyhole 122. The cam 123 may be separately formed and connected to the lock cylinder 121 with a suitable fastener, or may be integrally formed with the lock cylinder 121. The cam 123 rotates between an unlocked position, a locked position, and a deadlocked position.

The follower 13 moves along a linear axis, and to accommodate the cam 123. The movement of the follower 13 corresponds to movement of the cam 123. When the cam 123 is in the unlocked position, the follower 13 is in a first position, and when the cam 123 is in the locked position, the follower 13 is in a second position. When the cam 123 is in the deadlocked position, the cam 123 is no longer located in the follower 13, and the follower 13 is locked into the second position.

The locking arm 14 has a deadlocked position and a free position, and is biased towards the deadlocked position. When the cam 123 is in the unlocked position or the locked position, the cam 123 abuts a surface of the locking arm 14, which holds the locking arm in the free position. When the cam 123 is in the deadlocked position, the cam 123 is rotated without contacting the locking arm 14, so that the locking arm 14 moves into the deadlocked position. When the locking arm 14 is in the deadlocked position, the locking arm 14 locks the follower 13 in the second position.

The lock assembly 10 is installed in a mortice of a lock stile of a sliding door. In some cases, this can mean that the lock body 11 is a relatively flat profile, and has a depth less than that of a sliding door.

The latch assembly 20 includes a snib 21, an actuator hub 22, and a latch mechanism in the form of a pair of actuator arms 23 in communication with a pair of counter-rotatable beaks 24. The actuator hub 22 and actuator arms 23 are located in a latch body 25. The latch assembly 20 has a latched mode in which the beaks 24 are extended to protrude from the latch body 25 and an unlatched mode in which the beaks 24 are withdrawn and do not protrude from the latch body 25.

The snib includes a handle 211 in communication with a square-profiled spindle 212. The spindle 212 is inserted into an aperture of an actuator hub 22 such that rotation of the spindle 212 causes equivalent rotation of the actuator hub 22. When a user pushes or pulls the handle 211 to cause rotation of the handle 211, the spindle 212 rotates, and thus causes the actuator hub 22 to rotate in a corresponding manner.

The actuator hub 22 has a pinion meshed with a rack of each actuator arm 23. As the actuator hub 22 rotates, the actuator arm 23 is moved linearly.

Each beak 24 is connected to the latch body 25 by a pin 26 which functions as a pivot point for the beak 24 allowing the beak 24 to rotate. Each beak comprises a cut-out 241 which interacts with a respective actuator arm 23.

Each actuator arm 23 has a slot 231 and a knob 232 at each side of the slot 231. The knob 232 engages with the cut-out 241 of the respective beak 24. In the unlatched rode, the knob 232 sits outside of the cut-out 241 and acts to retain the beak 24 within the latch body 25. When the latch assembly moves from the unlatched mode to the latched mode, the knob 232 moves in concert with the actuator arm 23 to enter the cut-out 241, and to push against one end of the cut-out 241. This causes the beak 24 to rotate about the pin 26, which causes the beak 24 to pass through the slot 231 and protrude from the latch body 25. When the latch assembly 20 moves from the latched mode to the unlatched mode, the knob 232 moves in concert with the actuator arm 23 so that the knob 232 pushes against the other end of the cut-out 241 of the respective beak 24. This causes the beak 24 to rotate about the pin 26, and become withdrawn within the latch body 25. When the latch assembly 20 is in the latched mode, each actuator arm 23 is positioned such that the knob 232 is still engaged with cut out 241 but the shape of the cut out 241 causes beak 24 to rotate around pin 26 and protrude or retract out and in of lock body 25. When in latch mode the engagement of knob 232 and cut out 241 locks beak 24 in place and does not allow beak 24 to retract back into latch body 25 when load is applied to the projecting out end of beak 24 (i.e. trying to force the beaks back into the lock body when the beaks are sticking out of the lock body. The beaks can only be retracted back into the lock body due to movement of the actuator 23). The interaction between the knob 232 and the cut-out 241 causes the beak 24 to rotate about the pin 26 such that an end of the beak 24 passes through the slot 231 and protrudes from the latch body 25.

Movement of the snib 21 causes the latch assembly to move between a latched mode in which the beaks 24 are extended and an unlatched mode in which the beaks 24 are withdrawn.

A drive plate 30 is connected atone end to an actuator arm 23 and at the other end to the follower 13. The drive plate 30 translates movement of one of the actuator arms 23 (and thus the actuator hub 22, the other actuator arm 23, and the snib 21) to movement of the follower 13 (and thus the cam 123). The drive plate may comprise an aperture 31 through which the head of a screw can pass. This allows the drive plate 30 to move in a linear motion without interference by a screw. In some embodiments, the drive plate 30 may be omitted, and one of the actuator arms 23 may incorporate the follower 13, and therefore may directly interact with the cam 123 and the locking arm 14. In such embodiments, references to the drive plate 30 should be construed as references to the corresponding actuator arm 23.

In FIG. 2, the cam 123 is shown in the unlocked position. This corresponds to the follower 13 being in the first position and the locking arm 14 being in the free position. When the follower 13 is in the first position, the drive plate 30 is positioned such that the latch assembly is in the unlatched mode. That is, because the follower 13 is in the first position, the drive plate 30 is positioned such that the actuator arm 23 connected to the drive plate 30 is in a position corresponding to the unlatched mode. Moreover, due to the rack-and-pinion communication between the actuator arms 23 and the actuator hub 22, the engagement between the knob 232 of each actuator arm 23 and the cut-out 241 of each respective beak 24, and the mating between the actuator hub 22 and the spindle 212, the other actuator arm 23, the pair of beaks 24, the actuator hub 22, and the snib 21 are similarly in positions corresponding to the unlatched mode.

FIG. 3 shows the lock assembly 10 and the latch assembly 20 of FIG. 2, in which the cam 123 is in the locked position. This corresponds to the follower 13 being in the second position and the locking arm 14 being in the free position. When the follower 13 is in the second position, the drive plate 30 is positioned such that the latch assembly is in the latched mode. That is, because the follower 13 is in the second position, the drive plate 30 is positioned such that the actuator arm 23 connected to the drive plate 30 is in a position corresponding to the latched mode. Due to the rack-and-pinion communication between the actuator arms 23 and the actuator hub 22 and the mating between the actuator hub 22 and the spindle 212, the other actuator arm 23, the actuator hub 22, and the snib 21 are similarly in positions corresponding to the latched mode.

Movement between the latched mode and the unlatched mode can occur by a user actuating the snib 21. This causes corresponding movement of the actuator hub 22, the actuator arms 23, the drive plate 30, the follower 13, and the cam 123. In addition, movement between the latched mode and the unlatched mode can occur by a user rotating a suitable key inserted into the keyhole 122. This causes corresponding movement of the cam 123, the follower 13, the drive plate 30, the actuator arms 23, the actuator hub 22, and the snib 21. In this manner, the cylinder lock 12 and the snib 21 can each be used to move the latch assembly between the latched and unlatched modes.

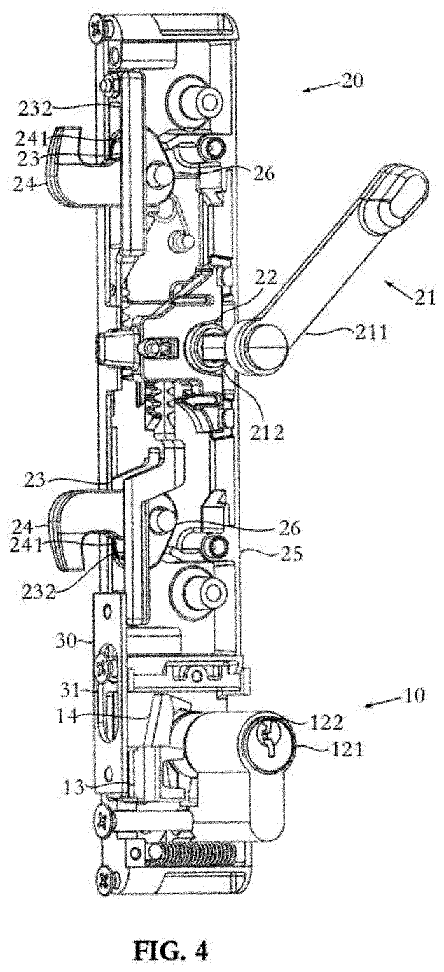

FIG. 4 shows the lock assembly 10 and the latch assembly 20 of FIG. 2, in which the cam 123 is in the deadlocked position. This corresponds to the locking arm 14 being in the deadlocked position to lock the follower 13 in the second position. When the cam 123 is in the deadlocked position, the latch assembly is in the latched mode in the same manner as is shown in FIG. 3.

In use, attempted movement of the snib 21 is substantially resisted due to the protrusion 144 of the locking arm 14 being positioned to align with the shoulder 135 of the follower 13. That is, attempted movement of the snib 21 leads, via the actuator hub 22, actuator arm 23, and drive plate 30, to attempted movement of the follower 13, which causes the shoulder 135 of the follower 13 to abut the protrusion 144 of the locking arm 14. In this manner, when the cam 123 is in the deadlocked position, the latch mechanism is locked into the latched mode.

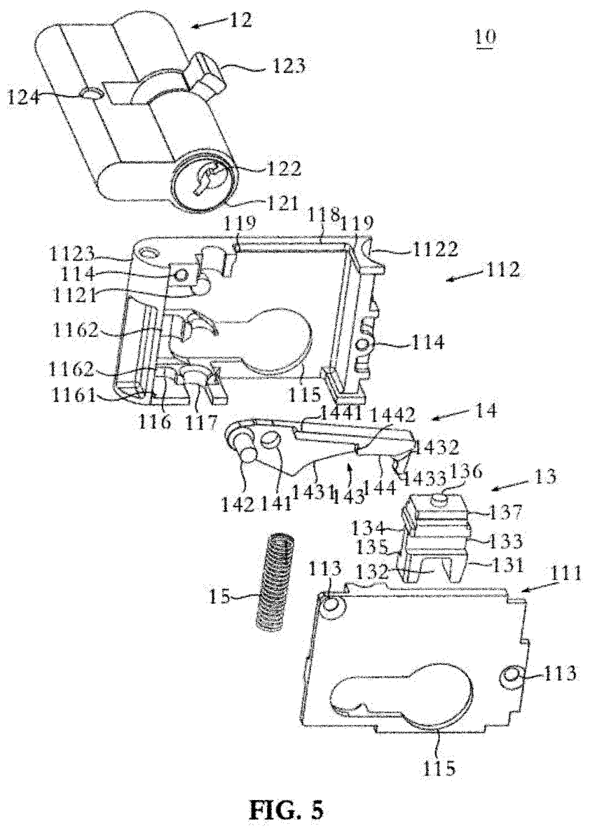

FIG. 5 shows a lock assembly 10, such as that shown in FIGS. 2 to 4, in further detail. The illustrated lock assembly 10 includes a lock body 11, cylinder lock 12, a follower 13, and a locking arm 14.

The cylinder lock 12 includes a lock cylinder 121 rotatable about an axis when a suitable key is inserted into a keyhole 122. A cam 123 rotates about the same axis. The cam 123 may be separately formed and connected to the lock cylinder 121 with a suitable fastener, or may be integrally formed with the lock cylinder 121. A screw hole 124 is provided to allow the cylinder lock 12 to be fastened in place.

In the displayed embodiment, the cylinder lock 12 may be a Euro cylinder lock which includes a single barrel accessible from one side of the sliding door, or a pair of oppositely facing barrels accessible from each side of the sliding door. A keyhole is provided in an end of each barrel so that a key can be used to turn the lock cylinder from both sides of the door. The cylinder lock 12 may have “float” in the cam 123 so that the cam 123 can move independently in relation to lock cylinder 121 at times. Because of this, the cam 123 may move between positions (such as the unlocked position and locked position) while the lock cylinder 121 does not move. However, in alternative embodiments, the cam 123 and the lock cylinder 121 can be fixed in relation to each other, so that movement in one causes equivalent movement in the other. In some cases, the cylinder lock could be a cam or tail bar type pin cylinder in which a tail bar may take the place of cam 123.

The cam 123 rotates between an unlocked position, a locked position, and a deadlocked position. In the displayed embodiment, the unlocked position and the locked position correspond to around 120 degrees and around 60 degrees of rotation respectively from the position of the deadlocked position.

The lock body 11 includes a front body portion 111 and a back body portion 112 fastened together with screws or rivets through holes 113 and 114. One end of the back body portion 112 has a generally concave half-cylindrical portion 1122 to allow the lock body 11 to mate with another component, such as a latch body. The other end of the back body portion 112 has a generally convex half-cylindrical portion 1123. This can aid installation of the lock assembly 10, as this allows for a slot-profile mortice.

A lock aperture 115 is formed in the front body portion 111 and back body portion 112, and allows a portion of the cylinder lock 12 to sit within the lock body 11. The back body portion 112 has a pin 1121 extending into the lock body 11 to connect to the locking arm 14. A spring channel 116 for receiving a spring 15 is formed in the lock body 11, and includes a wall 1161 against which one end of the spring 15 can press, and a series of cradles 1162 to hold the spring generally in place. A screw path 117 for receiving a screw is formed in the lock body 11 when the front body portion 111 and the back body portion 112 are connected. When the cylinder lock 12 is installed, the screw path 117 aligns with the screw hole 124 so that the cylinder lock 12 can be fastened to the lock body 11. In addition, a follower aperture 118 is formed by the front body portion 111 and back body portion 112 for the follower 13.

The lock assembly 10 has a linking member in the form of a follower 13 having a pair of fingers 131 defining a recess 132 which accommodates the cam 123. The recess 132 may have a generally rounded rectangular cross-section. The width of the recess can have a width (being the dimension along the axis of travel of the follower 13 between the first position and the second position) between around 1.5 times to around 2.0 times the width of the cam 123, to accommodate the cam 123 in a variety of angles and to allow the cam 123 to disengage when the cam 123 moves into the second lock position, in addition, the recess may have a depth (being the dimension along an axis perpendicular to that of the width) between around 1.5 times to around 2.0 times the height of the cam 123.

The follower 13 has a first groove 133 which engages a protrusion on the inner face of the front body portion 111. This maintains the movement of the follower 13 in a linear axis along the length of the follower aperture 118. The faces 137 of the follower 13 also abut the edges around aperture 118, to further align the follower 13 along the axis. This linear axis is transverse to the axis of rotation of the cam 123. At each end of the follower aperture 118 there is an abutment 119 such that the follower 13 generally cannot proceed beyond the first position or the second position.

The follower 13 has a second groove 134 and a shoulder 135 on one side of the groove for interacting with a locking arm 14, and a protrusion 136 to allow the follower 13 to interact with another assembly, such as a latching assembly.

The lock assembly 10 includes a locking arm 14. The locking arm 14 has an aperture 141 designed to mate with the pin 1121, providing a pivot point for the locking arm 14. The locking arm 14 has a deadlocked position and a free position, which correspond to different degrees of rotation about the pivot point. The spring 15 connects to a pin 142 of the locking arm. The spring 15 is under tension and pushes against the wall 1161 to bias the locking arm to rotate about the pin 142 into the deadlocked position.

The locking arm 14 has a cam guide 143 along which the cam 123 can slide as the cam 123 rotates. The cam guide 143 has an arcuate portion 1431 corresponding to the position of the cam 123 between the locked position to the unlocked position, a flat portion 1432 corresponding to the position of the cam 123 when the cam 123 is in the unlocked position, and a boot 1433 against which the cam 123 would abut if the cam 123 were attempted to be rotated further clockwise beyond the unlocked position. In this manner, in some embodiments the locking arm 14 can prevent over-rotation of the cam 123 in one direction.

The locking arm 14 also includes a generally L-shaped protrusion 144 with a first portion 1441 and a second portion 1442. When the locking arm 14 is in the free position, the locking arm 14 is aligned so that one or both of the first portion 1441 and the second portion 1442 sits within the second groove 134. In addition, the first portion 1441 may abut one face of the second groove 134 to prevent the locking arm 14 from moving away from the cam 123. This may in turn cause the cam 123 to have some resistance while turning. When the locking arm 14 is in deadlocked position, and thus the follower 13 is in the second position, the shoulder 135 of the follower 13 may abut the second portion 1442 of the protrusion 144. This can prevent movement of the follower 13 towards the first position.

To accommodate the protrusion 144, the second groove 134 may have a width at least as large as the second portion 1442, and preferably at least 5 mm larger, to allow for uninhibited movement of the protrusion 144 along the second groove 134 when the locking arm 14 is in the free position.

The lock assembly 10 is installed in a mortice in a lock stile of a sliding door. This can mean that the lock body 11 is of a relatively flat profile, and having a depth less than that of a sliding door.

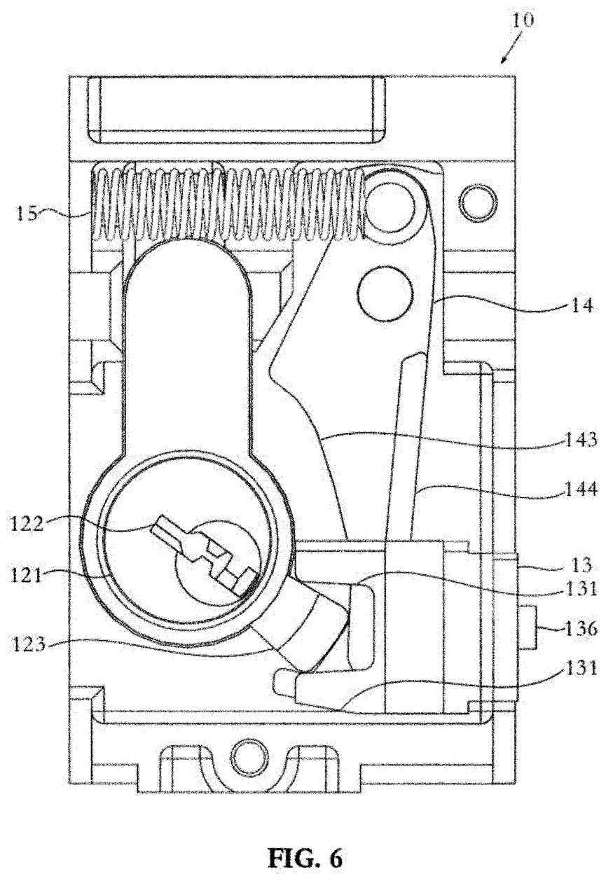

FIG. 6 shows the lock assembly 10 when the cam 1231s in the unlocked position, the follower 13 is in the first position, and the locking arm 14 is in the free position. The cam 123 of the cylinder lock 12 engages with the cam guide 143 of the locking arm 14. This resists the biasing of the spring 15 such that the locking arm 14 remains in the free position. Because the locking arm 14 is in the free position, the protrusion 144 of the locking arm 14 is aligned with the second groove 134 of the follower 13, so that the follower 13 can freely move between the first position and the second position without interference by the locking arm 14.

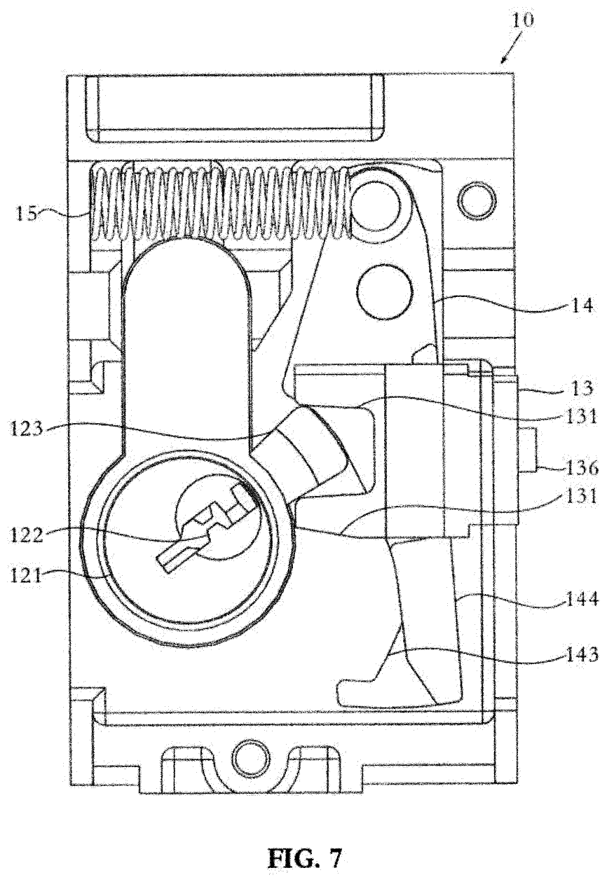

FIG. 7 shows the lock assembly 10 when the cam 123 is in the locked position. Movement from the unlocked position to the locked position of the cam 123 can occur from a user turning a suitable key in keyhole 122 to apply rotational force to the lock cylinder 121 in an anti-clockwise direction. In this case, rotation of the lock cylinder 121 causes consequent rotation of the cam 123. Due to the position of the cam 123 within the fingers 131, the follower 13 is urged into the second position. Alternatively, movement from the unlocked position to the locked position can occur from force applied to the follower 13. For example, this may occur in response to a user actuating a snib which is in communication with the follower 13 via a drive plate connected to the protrusion 136 of the follower 13. In this case, linear movement of the follower 13 causes the fingers 131 to urge the cam 123 to rotate into the locked position.

In either case, the cam 123 slides along the cam guide 143 of the locking arm 14. The cam 123 therefore resists the biasing of the spring 15 on the locking arm 14 such that the locking arm 14 remains in the free position. Because the locking arm 14 is in the free position, the protrusion 144 of the locking arm 14 is aligned with the second groove 134 of the follower 13, so that the follower 13 can freely move between the first position and the second position without interference by the locking arm 14.

Movement from the locked position to the unlocked position can occur through in similar manners. That is, this can occur from a user turning a suitable key in keyhole 122 to apply rotational force to the lock cylinder 121 in a clockwise direction. This causes consequent rotation of the cam 123. The cam 123 engages with the fingers 131 to translate the rotational movement of the cam to linear movement of the follower 13 from the second position to the first position. Alternatively, this can occur from linear force applied to the follower 13. The fingers 131 then engage the cam 123 to cause rotational movement from the locked position to the unlocked position.

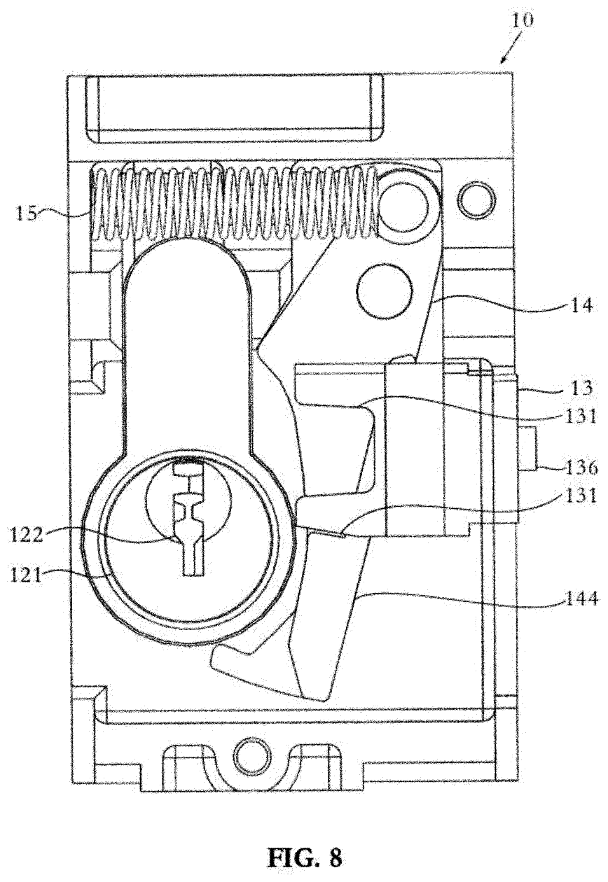

FIG. 8 shows the lock assembly 10 when the cam 123 is in the deadlocked position. Movement from the locked position to the deadlocked position occurs from a user turning a suitable key in keyhole 122 to apply rotational force to the lock cylinder 121 in an anti-clockwise direction. Rotation of the lock cylinder 121 causes consequent rotation of the cam 123 such that the cam 123 no longer protrudes from the cylinder lock 12. The cam 123 consequently does not sit within the fingers 131 of the follower 13 and no longer contacts the cam guide 143 of the locking arm 14. Because of this, the biasing of the spring 15 is no longer resisted by the cam 123. The locking arm 14 therefore rotates about the pin 1121 to move into the deadlocked position.

When the locking arm 14 is in the deadlocked position, the protrusion 144 of the locking arm is aligned with the shoulder 135 of the follower 13. The follower 13 is therefore locked into the second position, and attempted movement of the follower 13 into the first position causes the shoulder 135 of the follower 13 to abut the protrusion 144 of the locking arm 14, such that movement of the follower 13 into the first position is substantially resisted.

Movement from the deadlocked position to the locked position of the lock cylinder 121 occurs from a user turning a suitable key in the keyhole 122 to apply rotational force to the lock cylinder 121 in a clockwise direction. This causes consequent rotation of the cam 123 such that the cam 123 comes into contact with the cam guide 143 of the locking arm 14. This forces the locking arm 14 to move into the free position, such that the protrusion 144 of the locking arm becomes aligned with the second groove 134 of the follower. In addition, rotation of the cam 123 causes the cam 123 to re-enter the recess 132 formed by the fingers 131 of the follower 13 to allow communication between the cam 123 and the follower 13.

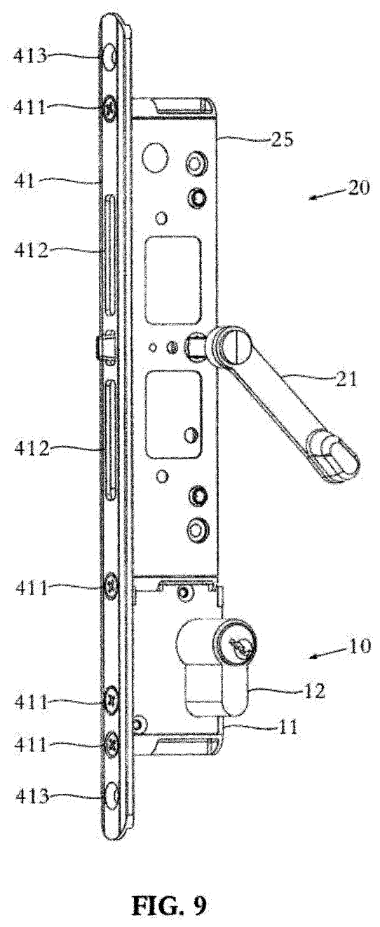

FIG. 9 shows an embodiment of a lockable latch assembly 40, including a lock assembly 10 and a latch assembly 20, such as that shown FIGS. 6 to 8. The lock assembly 10 is shown having the lock body 11 installed, and the latch assembly is shown having the latch body 25 installed. The cylinder lock 12 and the snib 21 respectively remain accessible when the lock body 11 and latch body 25 are installed.

The lock body 11 is shaped to mate with the latch body 25. For example, the shape of the top of the lock body 11 is substantially convex to sit against the substantially concave bottom of the latch body 25.

A forend plate 41 is connected to aside of the lock assembly 10 and the latch assembly 20 by means of screws 411. In addition, the forend plate has apertures 412 aligned with slots 231 such that when the latch assembly is in the latched mode, the beaks 24 can protrude though the apertures 412. The forend plate 41 allows the drive plate 30 to move even when the forend plate 41 is installed. For example, the forend plate 71 may include a recess to accommodate the drive plate 30.

The lockable latch assembly 40 is installed in a mortice in a lock stile of a sliding door such that the lock body 11 and the latch body 25 are wholly positioned within the mortice. To this end, the depth of the lock body 11, the latch body 25, and the forend plate 41 are relatively slim in profile, and are shallower than the depth of the sliding door. The forend plate is provided with screw holes 413 through which a screw can be used to fasten the lockable latch assembly 40 to the sliding door. In addition, the lock aperture 115 and the actuator hub 22 are positioned to align with corresponding apertures in the sliding door. This allows the cylinder lock 12 and the snib 21 to be accessible from a side of the sliding door.

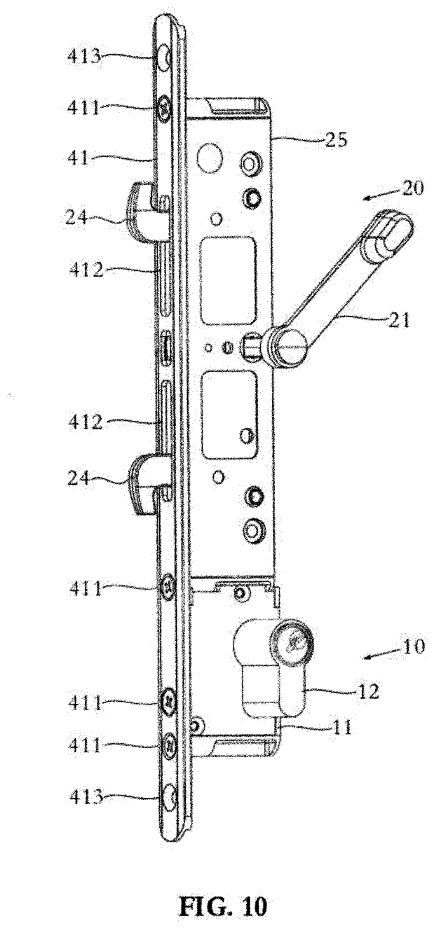

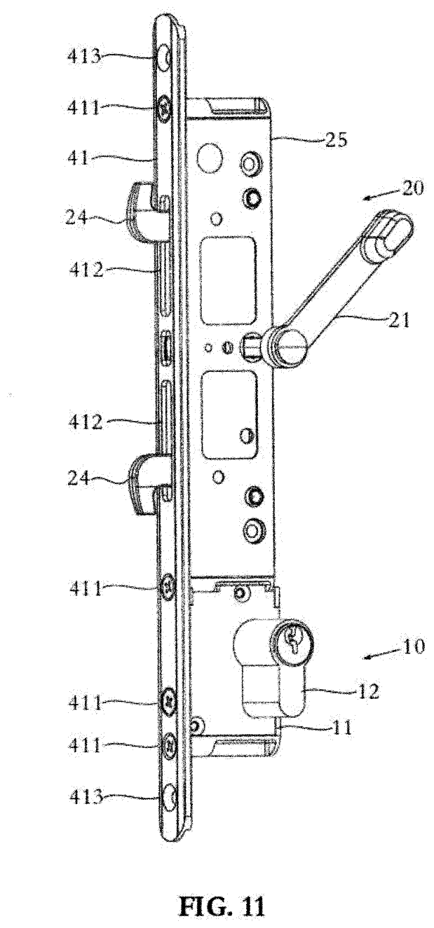

FIGS. 10 and 11 show the lockable latch assembly 40 in which the latch assembly 20 is in a latched mode and the cam 123 is in the locked position and deadlocked position respectively. To this end, beaks 24 are shown extended and protruding through the apertures 412 of the forend plate 41. In use, the extended beaks can engage with a strike plate in a jamb of a door frame to hold the sliding door in place until the latch assembly is moved into an unlatched mode.

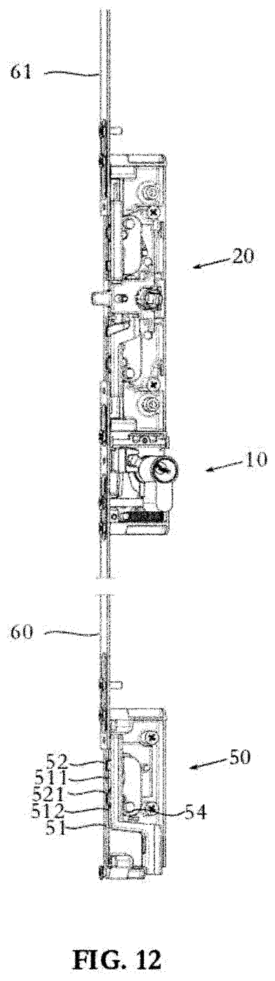

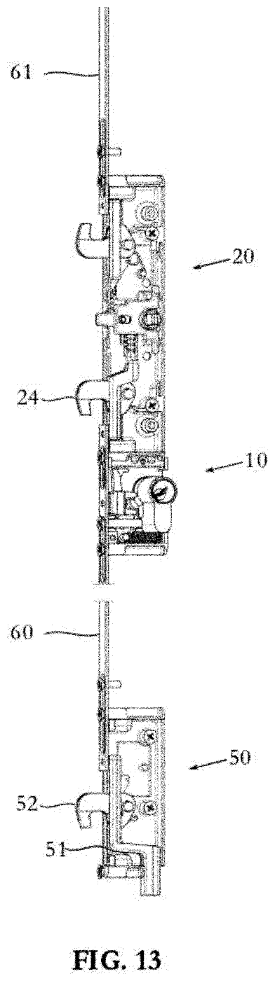

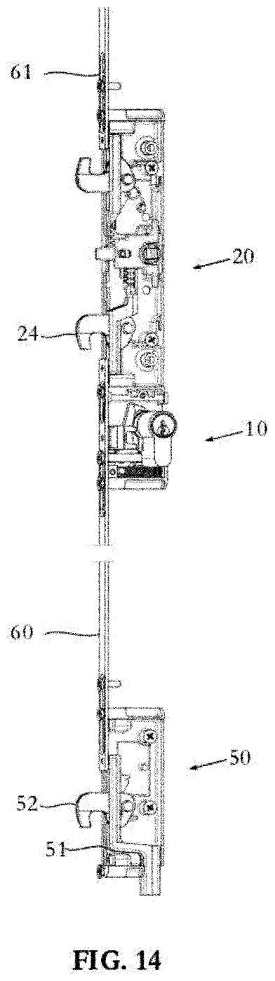

FIG. 12 shows a lock assembly 10 and a latch assembly 20, such as those shown in FIGS. 6 to 11, in communication with a secondary latch mechanism 50.

The secondary latch mechanism 50 includes an actuator arm 51 and a beak 52. The secondary latch mechanism 50 has a latched mode in which the beak 52 is extended to protrude from the latch body 53 and an unlatched mode in which the beak 52 is withdrawn and not protrude from the latch body 53.

The beak 52 is connected to the latch body 53 by a pin 54 which functions as a pivot point for the beak 52 allowing the beak 52 to rotate. The beak comprises a cut-out 521 which interacts with the actuator arm 51.

The actuator arm 51 has a slot 511 and a knob 512 at each side of the slot 511. The knob 512 engages with the cut-out 521 of the beak 52. In the unlatched mode, the knob 232 engages the cut-out 521 and acts to retain the beak 52 within the latch body 503. When the secondary latch mechanism moves from the unlatched mode to the latched mode, the knob 512 moves in concert with the actuator arm 51 to move within the cut-out 521, and to push against one end of the cut-out 521. This causes the beak 52 to rotate about the pin 54, which causes the beak 52 to pass through the slot 511 and protrude from the latch body 503.

A drive bar 60 is connected to an actuator arm 23 of the latch assembly, the follower 13 of the lock mechanism, and the actuator arm 51 of the secondary latch mechanism. The drive bar 60 translates movement of the actuator arm 23 of the latch assembly, the follower 13 of the lock assembly 10, and the actuator arm 51 of the secondary latch mechanism 50. In this manner, when the latch assembly 20 is in the latched mode or unlatched mode, the secondary latch mechanism 50 is in the corresponding latched mode or unlatched mode.

A further drive bar 61 may be provided to connect the other actuator arm 23 of the latch assembly 20 to another secondary latch mechanism 50. In this manner, multiple secondary latch mechanisms can be provided which are simultaneously in the latched mode or the unlatched mode.

In some cases, the drive bars 60 and 61 may move along a different face of lock assembly 10, latch assembly 20, and secondary latch mechanism 50. For example, they may move along the back (that is, the end furthest within the mortice). In addition, the drive bars 60 and 61 may be tubes or the like.

In FIG. 12, the cam 123 of the lock assembly 10 is in the unlocked position. Due in part to the drive bar 60, this corresponds to the latch assembly 20 being in the unlatched mode and secondary latch mechanism 50 being in the unlatched mode.

FIG. 13 shows the arrangement of FIG. 12 in which the cam 123 is in the locked position. Due in part to the drive bar 60, this corresponds to the latch assembly 20 being in the latched mode in which the beaks 24 are extended, and to secondary latch mechanism 50 being in the latched mode in which beak 52 is extended.

FIG. 14 shows the arrangement of FIG. 12 in which the cam 123 is in the deadlocked position. This corresponds to the latch assembly 20 being in the latched mode in which the beaks 24 are extended, and to secondary latch mechanism 50 being in the latched mode in which beak 52 is extended. In addition, due to the protrusion 144 of the locking arm being positioned to align with the shoulder 135 of the follower 13, the follower 13 is locked in place. This consequently leads to the actuator arms 23 of the latch assembly and the actuator arm 51 of the secondary latch mechanism being locked into the latched mode.

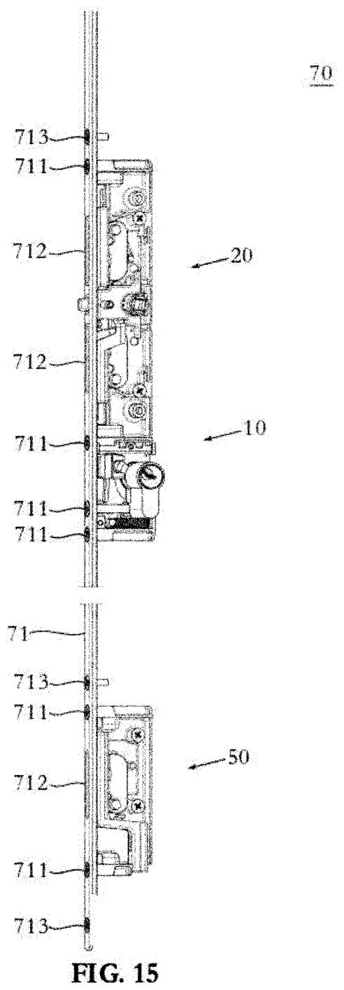

FIG. 15 shows an embodiment of a lockable multi-latch assembly 70, which includes a lock assembly 10, a latch assembly 20, the secondary latch mechanism 50, and a drive bar 60 such as those shown in FIGS. 12 to 14.

A forend plate 71 is connected to a side of the lock assembly 10, the latch assembly 20, and the secondary latch mechanism 50 by means of screws 711. In addition, the forend plate includes apertures 712 aligned with slots 231 such that when the latch assembly is in the latched mode, the beaks 24 can protrude though the apertures 712.

The forend plate 71 allows the drive bar 60 to move even when the forend plate 71 is installed. For example, the forend plate 71 may include a recess to accommodate the drive bar 60.

The lockable multi-latch assembly 70 is installed in at least one mortice in the lock stile of a sliding door. For example, a single mortice can be provided such that the lock body 11, the latch body 25 of the latch assembly, and a latch body of the secondary latch mechanism are wholly positioned within the mortice. Alternatively, multiple mortices can be provided, such that a first mortice may accommodate the lock body 11 and the latch body 25 of the latch assembly and a second mortice can accommodate the latch body of the secondary latch mechanism. In either case, the depth of the lock body 11, the latch body 25, the latch body of the secondary latch mechanism, and the forend plate 71 are relatively slim in profile, and are shallower than the depth of the sliding door. The forend plate 71 is provided with screw holes 713 through which a screw can be used to fasten the lockable multi-latch assembly 70 to the sliding door. In addition, the lock aperture 115 and the actuator hub 22 are positioned to align with corresponding apertures in the sliding door. This allows the cylinder lock 12 and the snib 21 to be accessible from a side of the sliding door.

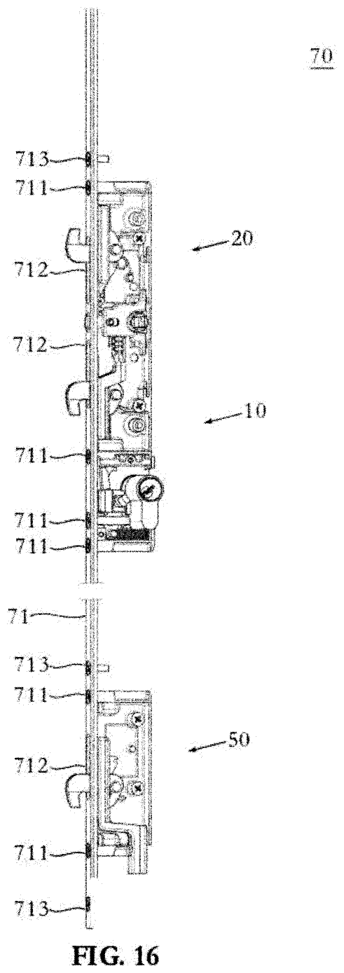

FIG. 16 shows the arrangement of FIG. 15 in which the cam 1231s in the locked position. Due in part to the drive bar 60, this corresponds to the latch assembly 20 being in the latched mode in which the beaks 24 are extended, and to secondary latch mechanism 50 being in the latched mode in which beak 52 is extended.

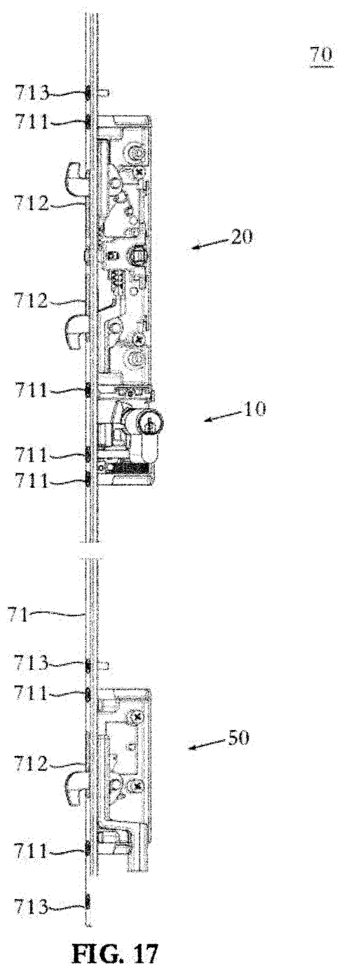

FIG. 17 shows the arrangement of FIG. 15 in which the cam 123 is in the deadlocked position. This corresponds to the latch assembly 20 being in the latched mode in which the beaks 24 are extended, and to secondary latch mechanism 50 being in the latched mode in which beak 52 is extended. In addition, due to the protrusion 144 of the locking arm being positioned to align with the shoulder 135 of the follower 13, the follower 13 is locked in place. This consequently leads to the actuator arms 23 of the latch assembly and the actuator arm 51 of the secondary latch mechanism being locked into the latched mode.

The term “comprise” and its variants are used in an inclusive sense, that is to include the stated integers but not to exclude any other, unless in the context an exclusive interpretation of the term is required.

The embodiments described above are illustrative only, and it will be apparent that various modifications and changes can be made without departing from the spirit and scope of the present invention.

What is claimed is:

1. A lock assembly comprising:
a lock body;
a rotatable lock cylinder comprising a portion movable within the lock body and configurable between an unlocked position, a locked position, and a deadlocked position; and
a linking member having a first position and a second position, wherein when the portion is in the unlocked position, the linking member is in the first position, when the portion is in the locked position, the linking member is in the second position, and when the portion is in the deadlocked position, the linking member is locked in the second position;
wherein the lock assembly is configured to be installed in a mortice of a sliding door, the sliding door having a latch mechanism within a latch body separate from the lock body, such that the linking member is in communication with the latch mechanism via a drive plate, drive bar or actuator arm configured to connect to the linking member and positioned outside the lock body.

2. The lock assembly of claim 1, wherein the portion comprises a cam or a tail bar.

3. The lock assembly of claim 2, wherein the linking member comprises a follower configured to interact with the portion.

4. The lock assembly of claim 3, further comprising a locking arm having a deadlocked position and a free position, wherein when the portion is in the unlocked position or the locked position, the linking member is respectively in the first position or the second position and the locking arm is in the free position, and when the portion is in the deadlocked position, the locking arm is in the deadlocked position to lock the linking member in the second position.

5. The lock assembly of claim 4, wherein the locking arm is biased towards the deadlocked position, wherein when the portion is in the unlocked position or the locked position, the portion holds the locking arm in the free position.

6. The lock assembly of claim 5, wherein the locking arm comprises a protrusion and the follower comprises a groove, wherein when the locking arm is in the deadlocked position, the protrusion engages the linking member to lock the linking member in the second position, and when the locking arm is in the free position, the protrusion aligns with the groove to allow the linking member to move between the first position and the second position.

7. The lock assembly of claim 3, wherein the follower comprises a pair of fingers, the portion acting on one or both fingers to actuate the linking member between the first position and the second position.

8. The lock assembly of claim 3, wherein the follower moves linearly along an axis transverse to the axis of rotation of the portion.

9. The lock assembly of claim 3, wherein rotation of the lock cylinder corresponds to rotation of the portion about the same axis.

10. The lock assembly of claim 1, wherein when the lock assembly is installed, the drive plate, drive bar or actuator arm translates movement of a snib of the sliding door to movement of the linking member.

11. The lock assembly of claim 10, wherein the linking member can move between the first position and the second position by movement of the snib.

12. (canceled)

13. (canceled)

14. A lockable latch assembly, comprising:
the lock assembly of claim 1; and
a latch mechanism comprising a latch, the latch mechanism having a latched mode in which a latch of the latch mechanism is extended and an unlatched mode in which a latch of the latch mechanism is withdrawn;
wherein when the portion of the lock assembly is in the unlocked position, the latch mechanism is in the unlatched mode, and when the portion of the lock assembly is in the locked position or the deadlocked position, the latch mechanism is in the latched mode.

15. The latch assembly of claim 14 wherein when the latch mechanism is not engaged with a jamb of the sliding door, the latch mechanism is locked in the unlatched mode.

16. The latch assembly of claim 14 further comprising the drive plate, wherein the drive plate is configured to be positioned outside the latch body when installed.

17. The latch assembly of claim 16, wherein the drive plate is configured to connect to an actuator arm of the latch mechanism when installed.

18. The latch assembly of claim 14, wherein the latch mechanism comprises the actuator arm.

19. A lockable multi-latch assembly, comprising:
the lock assembly of claim 1; and
two or more latch mechanisms in communication with the lock assembly, each latch mechanism comprising a latch, and having a latched mode in which a latch of the latch mechanism is extended and an unlatched mode in which a latch of the latch mechanism is withdrawn;
wherein when the portion of the lock assembly is in the unlocked position, each latch mechanism is in the unlatched mode, and when the portion of the lock assembly is in the locked position or the deadlocked position, each latch mechanism is in the latched mode.

20. The multi-latch assembly of claim 19, further comprising a forend plate to which the lock assembly and each latch mechanism are connected.

21. The multi-latch assembly of claim 19 further comprising the drive bar, wherein the drive bar is configured to connect to respective actuator arms of the latch mechanisms when installed.

22. A sliding door having one or more mortices, wherein the lock assembly of claim 1 is installed in one or more of the mortice.
